(19) United States
(12) Patent Application Publication
(10) Pub. No.: US 2014/0172732 A1
(43) Pub. Date: Jun. 19, 2014

(54) PSYCHOGRAPHIC BASED METHODS AND SYSTEMS FOR JOB SEEKING

(71) Applicant: Roy Baladi, Wilmington, DE (US)

(72) Inventor: Roy Baladi, Wilmington, DE (US)

(21) Appl. No.: 13/714,456

(22) Filed: Dec. 14, 2012

(51) Int. Cl. G06Q 10/10

(52) U.S. Cl. CPC G06Q 10/1053
USPC 705/321

(57) ABSTRACT

A computer-implemented method for job seeking is disclosed. The method includes receiving a user request to search job openings, which request includes desired work field and user education information. Responsive to the user request, the user is prompted to provide information comprising one or more assertions associated with the user preferences with respect to one or more skills, abilities, work activities and one or more work styles. Further, based on the user request and the provided information, scores associated with a plurality of predetermined occupations are calculated. The scores identify how the user is favorable for every predetermined occupation. The method then identifies and displays a list of predetermined occupations being the most favorable for the user. The user is then prompted to select one or more predetermined occupations, and responsive thereto, the user is selectively provided with a list of job openings associated with the selected predetermined occupations.

### CROSS-REFERENCE TO RELATED APPLICATIONS

This application is related to U.S. Utility patent application Ser. No. 13/492,810, filed Jun. 9, 2012, titled: “Methods and Systems for Creating Psychographic Resumes,” which is hereby incorporated by reference in its entirety.

### TECHNICAL FIELD

This disclosure relates generally to data processing and, more particularly, to computer-implemented methods and systems for job seeking which are designed to identify job occupations most favorable for candidates based on assessments of their skills, their interests, their social connections, and/or their psychographic portraits.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Job listing providers generally provide searchable databanks of job listings related to employment opportunities and currently vacant job openings. Today, job listing providers are widely common in the Internet allowing job seekers to visit corresponding websites and search job openings based on search keywords entered by the jobseekers. Typically, search results include job listings that have description information that matches the search keywords. However, search results often include job listings that may not be relevant to the jobseeker. Moreover, the jobseekers often do not know what job role they would like to occupy and in what field they would be more efficient and productive. As a result, the jobseekers search requests often reveal irrelevant job listings and, in general, it can be difficult for the jobseekers to find job openings suitable for them based on their skills, interests, knowledge, and/or experience.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present technology, generally speaking, enables job seekers to perform online searches of job openings based on assessments of their skills and their interests, every word on their resume, their ideal job, passions, and their social connections. More specifically, in the course of online job seeking, a job seeker generates a request identifying an area of interest (desired work field) and education information such as a job seeker's major and their education degree (Bachelor's, Master's or Doctorate). Based on the request, the job seeker is then prompted to make assertions with respect to a predetermined list of skills, abilities, work activities, and work styles by comparing his or her preferences and skill level to given skills, abilities, work activities, and work styles. These assertions can be provided by the job seeker by filling out a graphical representation of a skill-like matrix, which is a two-dimensional chart in which abscissa represents the level of preference, while the axis of ordinates represents a skill level (or vice versa). Particularly, the job seeker may point to places for given list of skills, abilities, work activities, and work styles on the skill-like matrix. In other words, the job seekers rate themselves: how much they enjoy performing certain tasks and how skilled they are at them.

The provided information, including the user request and the assertions, is then used to calculate scores to a list of predetermined occupations (e.g., all available occupations in the market place). The job seeker may provide additional information such as description of their ideal job, their passions, personal information, employment history, education information, training information, awards/honors, skills, self-reported ideal employment, and so forth. Once this additional information is provided or the job seeker makes any changes to the skill-like matrix, the scores associated with the list of predetermined occupations can be recalculated. The scores associated with each predetermined occupation provide an objective metric that recommends career directions for the job seeker with the particular profile. In other words, the scores identify how the job seeker is favorable for every predetermined occupation.

Further, based on the calculated scores, a list of predetermined and most favorable occupations for the job seeker is created. In an example, ten predetermined occupations having the highest or lowest scores can be provided. Moreover, the list of these occupations can be sorted. The job seeker is then prompted to select at least one of the provided occupations and, once the at least one of the provided occupations is selected, the job seeker is then provided with a list of current job openings associated with the selected occupations. In an embodiment, the job openings can be also sorted by relevance, degree of similarity with the job seeker's profile, and other parameters.

Thus, the present technology provides a very efficient online tool for job seeking by identifying the occupations, and corresponding job openings pertaining to these occupations, which are the most favorable to the job seekers. Job seekers who do not know the job role that would be suitable for them will find the present technology very helpful in determining the work fields, occupations, and job openings in the present job market.

Furthermore, the information provided by the job seekers, such as personal information, education information, employment information, skill-like matrices, and the like, can then be used to generate personal profiles and resumes in the form of an electronic document such as a website or a part of a website. Within the scope of the present disclosure, the resumes having the skill-like matrices are termed “psychographic resumes.”

According to various embodiments, the job seeker information, such as personal information, education information, employment information, and the like, can be automatically downloaded from a website, such as a social media site or similar site, having a corresponding profile of the job seeker. In addition, the present technology can search job seeker connections via social media sites and generate a list of companies where the job seeker has personal connections with people who work for the companies that are listed in the job openings. The present technology can then combine the list of companies and the list of job openings to additionally score the job openings. Finally, the present technology recommends a list of job openings for which the job seekers may apply and invites them to connect with their personal connections.

The present technology can be implemented by software, hardware, or a combination thereof. It can also use a distributed hardware components connected via a network such as the Internet. Those skilled in the art will appreciate that the job seekers may use any suitable electronic device, such as a personal computer (PC), laptop computer, tablet computer, wireless telephone, and the like, while the processes described herein can be performed by a remotely located server. The job seeking can be performed by the job seekers by visiting a dedicated website or by using a software application running on the electronic device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for creating and searching composite psychographic resumes, according to an example embodiment.

FIG. 2 is a diagram of a resume creating system, according to an example embodiment.

FIG. 3 is a diagram of a job seeking system, according to an example embodiment.

FIG. 4 is a process flow diagram showing a method for creating the composite psychographic resume, according to an example embodiment.

FIG. 5 is a process flow diagram showing a method for creating composite psychographic resumes, according to an example embodiment (continued from FIG. 4).

FIG. 6 is a simplified illustration of a graphical user interface of a web page representing the composite psychographic resume, according to an example embodiment.

FIG. 7 is a process flow diagram showing a method for job seeking, according to an example embodiment.

FIG. 8 is a simplified illustration of a graphical user interface of a web page suitable for generating a user request, according to an example embodiment.

FIG. 9 is a simplified illustration of a graphical user interface of a web page suitable for generating a skill-like matrix, according to an example embodiment.

FIG. 10 is a simplified illustration of a graphical user interface of a web page suitable for providing and selecting one or more predetermined occupations, according to an example embodiment.

FIG. 11 is a simplified illustration of a graphical user interface of a web page suitable for providing a list of job openings, according to an example embodiment.

FIG. 12 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations, in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

For the purposes of this disclosure, a psychographic resume is a resume that is based on attributes relating to experience, skills, personality, values, attitudes, interests, or lifestyles; may include one or more user assertions associated with one or more jobs offered by an employer and related to user skills and abilities, user experience, user training, or user preferences; and comprises a skill-like matrix and, optionally, a portfolio of works. In some example embodiments, the one or more user assertions may be associated with an industry or sector in which the one or more jobs are offered.

According to various embodiments disclosed herein, methods and systems for creating and searching psychographic resumes are disclosed. The composite psychographic resumes may be intelligently created in such a way that they will comprise, among other things, a customized “skill-like” matrix. The skill-like matrix may be represented as a two-dimensional data array comprising a set of skills that a particular job applicant may possess and/or need to have for a particular job role, as well as a set of knowledge levels and a set of preference levels associated with these skills, which define how well the job applicant knows or does not know certain skills and how the job applicant likes or dislikes certain skills. According to various embodiments, the skill-like matrix may be visualized as a two-dimensional chart and incorporated into the composite psychographic resume.

The qualifications may comprise one or more data related to education and training. The employment history may comprise one or more data related to current and past jobs of the job seeker. Thus, for example, the job seeker may be asked to provide a field of work, personal skills, technical skills, available start date, relocation preferences, references from previous and/or current employers, prior employment, and current employment status.

The education history may comprise data related to an education received by the job seeker. Thus, for example, this data may include a name of a university or some other institute of higher learning, university major, degree type, languages spoken, professional courses completed, and so forth.

In the same or other embodiments, the system may prompt the job seeker to input one or more assertions associated with one or more jobs offered by an employer and related to job seeker skills and abilities, job seeker experience, user training, or job seeker preferences and/or the one or more job seeker assertions associated with an industry or sector in which the one or more jobs are offered. In the same or other embodiments, the one or more assertions associated with the industry or sector that the one or more selected jobs are offered in may be related to user skills and abilities, job seeker experience, job seeker training, or job seeker preferences. The above may enable the employer to better understand how well the job being offered to the job seeker fits the job seeker (applicant or user, as further used herein), what skills the user is prepared to acquire, the length of time the job seeker intends to stay in the job offered, what vision of specifics and prospects the user has associated with the industry or sector in which the job is offered, and so forth.

The method further comprises generating the skill-like matrix based on the one or more assertions associated with one or more jobs offered by an employer and related to job seeker skills and abilities, job seeker experience, job seeker training, or job seeker preferences, and/or the one or more job seeker assertions associated with an industry or sector in which the one or more jobs are offered. The skill-like matrix may include information for a plurality of job roles selected by the job seeker.

The method may further comprise prompting the job seeker to upload a portfolio of works and update the resume with the portfolio of works to constitute an integral part of the composite psychographic resume. The method may further comprise storing created composite psychographic resumes in a database.

In some embodiments, when the skill-like matrix comprises the one or more assertions associated with the industry in which the one or more jobs in question are offered, such one or more assertions may also be evaluated based on predetermined rankings and used in calculating the score.

In some example embodiments, the composite psychographic resume may be created for the one or more job roles, and may comprise a calculated score; the skill-like matrix that has been generated; the one or more assertions associated with the job the user perceives as optimal/ideal; the one or more user assertions associated with the one or more jobs offered by an employer and related to job seeker skills and abilities, job seeker experience, job seeker training, or job seeker preferences and/or the one or more job seeker assertions associated with an industry or sector in which the one or more jobs are offered; and the education history, employment history, personal and educational accomplishments, and the portfolio of works of the job seeker. In the same or other embodiments, the composite psychographic resume may include credentials from previous employers of the user and/or one or more generated recommendations for applying the composite psychographic resume in one or more specific work fields.

The composite psychographic resumes of job applicants may further comprise other sections describing personal data of the job applicants (name, age, photo, and contact information), qualifications, employment histories, personality traits, and so forth. According to some embodiments, the composite psychographic resumes may also comprise answers to certain questions typical for the selected job role (e.g., “What would be your ideal job in . . . ?”, “What attracts you to it?”, etc.).

The composite psychographic resumes may be created in the form of electronic documents (e.g., web pages or a part of a web page) and stored in a remote database. The process of creating the resume may be performed online via a network such as the Internet.

According to various embodiments disclosed herein, prospective employers may search and review the composite psychographic resumes stored in the database. The way the search is performed is also intelligent in the sense that it may be focused on the skill-like matrices of multiple job applicants. Specifically, the recruiters may generate a search request and select certain qualifications and/or input desired keywords to retrieve and sort corresponding composite psychographic resumes of job seekers possessing the needed qualifications. The search results may be displayed as a list of job seekers, briefly showing qualifications and skill-like matrices of the job seekers represented as two-dimensional charts. Thus, it has been shown that reviewing of the two-dimensional charts associated with a plurality of job seekers who have approximately the same qualifications (e.g., students of the same university), but different skill-like data arrays, may allow recruiters to get an insight into skills and abilities of certain persons in a quick, visually easy, and convenient way. Just by looking at such skill-like charts, the recruiters may easily understand that a prospective job applicant will be good in one or another field. For example, the recruiter may readily understand that the prospective job applicant may be good in research, but rather mediocre in sales or marketing.

In some other examples, such resume analysis may be performed automatically. For this purpose, a score may be calculated based on the one or more assertions inputted by a job seeker. The one or more assertions may include a set of skills that a particular job seeker may possess and/or need to have for a particular job role (i.e., a set of knowledge levels for each skill may be used), and a set of preference levels related to the above skills defining how the job applicant likes or dislikes these skills. The score may be calculated on the basis of comparing the one or more assertions associated with the sets of the predetermined skills and abilities of the job seeker (also referred to herein as a user or job applicant), or with the one or more other assertions of the job seeker and related rankings, and determining the differences between them or a corresponding derivative of the differences.

In some embodiments, the psychographic resume of the user and job opening descriptions may be compared to identify possible matches. The identified matches may be used as one or the components of the score calculation and/or selecting job openings for the user.

In the same or other example embodiments, the above differences may be determined using a variety of methods and techniques, including splines, least squares, interpolation, and more.

Thus, for multiple inputted skills, the score may be generated as a data array or a vector. Subsequent matching of the score to the predetermined vectors associated with an optimal job candidate and determining differences between the two may be used to automatically determine how well a certain job applicant fits the job requirements, recommend that the job applicant take a certain training program to meet the job requirements, or recommend one or more fields of work more suitable for a certain job applicant.

Further, according to various embodiments, the job seekers may be prompted to indicate not only the skills that the job seekers have but also skills that the job seekers lack, and, similarly, to indicate not only skills the job applicants like, but also skills the job applicants dislike. More specifically, the skill-like matrix may be generated in such way that once a skill that the job seeker likes is inputted by the job seeker, the job seeker may be prompted to input at least one skill the job seeker dislikes in order to input another skill that the job seeker likes. Similarly, once the job seeker inputs a skill that the job seeker possesses, the job seeker may be prompted to input at least one skill the job seeker does not possess in order to be able to input another skill that the job seeker does possess. This approach allows generating a true skill-like matrix having a variety and range of skills, which allows for easily understanding the psychographic traits of the job seeker.

In some example embodiments, a further score may be calculated based one or more relevant skills that the user lacks and/or a job responsibility the user dislikes. The further score may be used to reduce the score associated with the skill-like matrix.

In some example embodiments, the one or more assertions may be ranked based on the predetermined rankings and used to reduce or increase the score associated with the skill-like matrix.

In some example embodiments, in order to determine how easily the job seeker can acquire one or more job-relevant skills indicated as lacking, a separate similarity score may be calculated. The similarity score may be calculated based on predetermined similarity rankings that link different job seeker skills to each other and signify how useful the one or more skills that the job seeker possesses may be in acquiring the one or more skills that the job seeker has indicated as lacking.

In some example embodiments, the differences or corresponding derivatives of the differences (e.g., squares of the differences) between the one or more assertions associated with one or more jobs offered by an employer and related to job seeker skills and abilities, job seeker experience, job seeker training, or job seeker preferences and/or the one or more job seeker assertions associated with an industry or sector in which the one or more jobs are offered, or the skill-like matrix of the job seeker on the one side, and the job description and/or a description of an optimal candidate on the other side, may be used to generate at least one recommendation with a view to further applying the composite psychographic resume in the one or more fields of work.

In some example embodiments, the skill-like matrix may be a two-dimensional chart in which abscissa represents the level of preference, while the axis of ordinates represents the skill level. In other example embodiments, the skill-like matrix may be a two-dimensional chart in which the abscissa represents the skill level, and the axis of ordinates represents the level of preference.

In some example embodiments, the psychographic resume may be hosted at a web server, wherein the psychographic resume is at least a part of a web page.

According to various embodiments disclosed herein, methods and systems for job seeking are disclosed. These methods and systems help job seekers to identify the occupations and job openings that may be the right fit for the job seekers based on an assessment of their skills and their interests and, optionally, based on every word on their resumes and their social connections. These methods can be very helpful for those job seekers who question which job role is suitable for them. For example, recently graduated students may not be aware of which job role would be ideal for them based on their qualification and interests. The embodiments disclosed herein provide a computer-implemented technique to find occupations being most favorable for the job seekers based on their education level, experience, skills, interests, and other parameters. This technique is also suitable for searching job openings corresponding to the occupations being most favorable for the job seekers.

In the same or other example embodiments, the job seeker may visit a dedicated website or use a software application to start searching occupations and job openings. The job seeker can generate a request via the website or software application. This request identifies an area of interest (desired work field) of the job seeker such as “patent examiner,” “attorney,” “electrical engineer,” and so forth. The request can also include education information such as a job seeker's major and their education degree (Bachelor's, Master's or Doctorate). Based on the request, the job seeker is then prompted to make one or more assertions with respect to a predetermined list of skills, abilities, work activities, and work styles. In particular, the job seeker is prompted to identify preferences and skill levels to given skills, abilities, work activities, and work styles. These assertions can be provided by the job seeker by filling out a graphical representation of skill-like matrix. As mentioned, the skill-like matrix can be represented as a two-dimensional chart in which abscissa represents the level of preference, while the axis of ordinates represents a skill level (or vice versa). Particularly, the job seeker may identify places for given list of skills, abilities, work activities, and work styles on the skill-like matrix. For this purpose, the job seeker can drag and place graphical blocks associated with the skills, abilities, work activities, and work styles at the skill-like matrix.

In the same or other example embodiments, the provided information from the user request and the assertions is then used to calculate scores for a list of predetermined occupations (e.g., all available occupation in the market place). The predetermined occupations can relate to multiple activities such as “software developer,” “attorney,” “dietitian and nutritionist,” “school psychologist,” “physician,” and so forth. The job seeker may provide additional information such as personal information, employment history, education information, training information, awards/honors, their skills, self-reported ideal employment, and so forth. Once such additional information is provided or the job seeker makes any changes to the skill-like matrix, the scores of the list of predetermined occupations can be recalculated. The scores associated with each predetermined occupation provide an objective metric that recommends career directions for the job seeker with the particular profile. In other words, the scores represent how the job seeker fits for every predetermined occupation.

In the same or other example embodiments, based on the calculated scores, a list is generated of predetermined occupations that are the most favorable for the job seeker. In an example, there can be provided ten predetermined occupations having the highest or lowest scores. Moreover, the list of these occupations can be sorted. The job seeker is then prompted to select at least one of the provided occupations, and once the at least one of the provided occupations is selected, the job seeker is then provided with a list of current job openings associated with the selected occupations. In an embodiment, the job openings can be also sorted by relevance, degree of similarity with the job seeker's profile, location, proposed salary, and other parameters. In an example embodiment, the job openings can be retrieved from a remotely located database or aggregated from multiple databases.

Those skilled in the art will appreciate that the embodiments described herein enable job seekers to identify those occupations, and corresponding job openings pertaining to those occupations, that are the most favorable for them. The job seekers who do not know the job role that would be suitable for them will find the present technology very helpful in determining the work fields, occupations, and job openings in the present job market.

In the same or other example embodiments, the information provided by the job seeker, such as personal information, education information, employment information, assertions, skill-like matrix, and the like, can then be used to generate personal profiles and custom psychographic resumes. As mentioned, the profiles and psychographic resumes can be generated in the form of electronic documents such as a website or a part of a website.

In the same or other example embodiments, the information provided by the job seeker, such as personal information, education information, employment information, and the like, can be automatically downloaded from a third party site such as a social media site having a corresponding profile of the job seeker. For this purpose, the system for job seeking may use an Application Programming Interface (API) of the third party site to access a job seeker's profile and import information associated with the job seeker's profile. This process can greatly facilitate the way in which the psychographic resume is created and save time for the job seeker.

In the same or other example embodiments, information regarding social media connections of the job seeker can be searched and retrieved from corresponding social media sites that have profiles of the job seeker. In particular, it can be determined whether the job seeker has any connections (e.g., “friends”) and if so, information about the job seeker's connections can be retrieved from the third party sites, such as social media sites. The information related to the job seeker's connections may include information about companies for whom the job seeker's connections work or with who they are in any other way associated. Further, there can be find a match between the job openings associated with certain companies and the job seeker's connections that relate to the same companies. In other words, a list can be generated of companies where the job seeker has personal connections with people who work for the companies that are listed in the job openings. The present technology can further combine the list of companies and the list of job openings to additionally score the job openings. Finally, the present technology recommends a list of job openings to which the job seeker might apply and invites the job seeker to connect with his personal connections.

The following provides the detailed description of various embodiments related to methods and systems for creating and searching the composite psychographic resumes as well as methods and systems for job seeking.

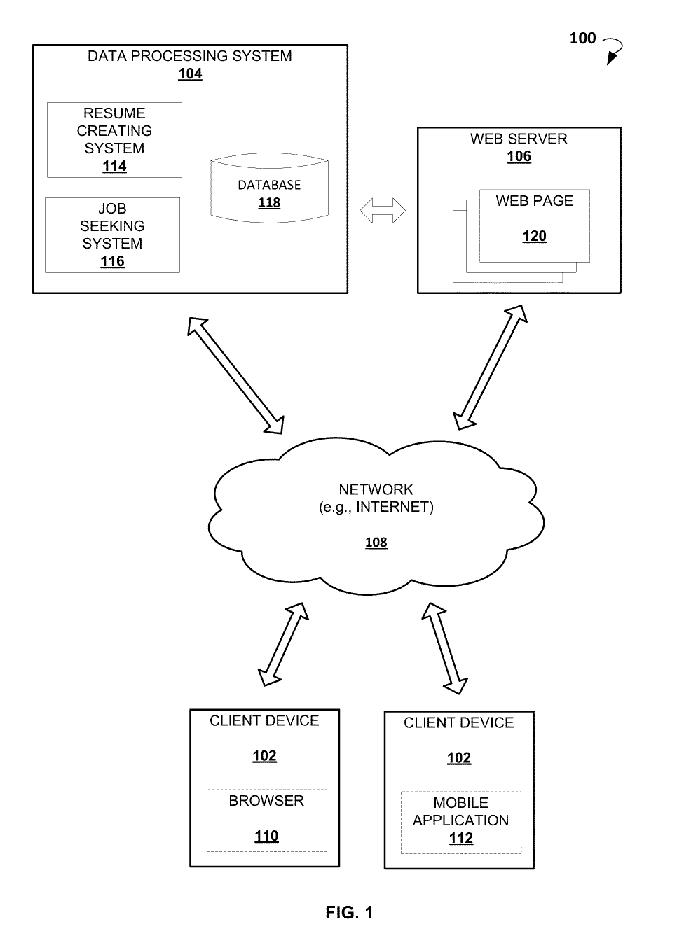

Referring now to the drawings, FIG. 1 shows a block diagram illustrating a system environment 100 suitable for creating and searching composite psychographic resumes, according to an example embodiment.

The system environment 100 comprises one or more client devices 102, a data processing system 104, a web server 106, and a network 108. The network 108 may couple the aforementioned modules.

The network 108 is a network of data processing nodes interconnected for the purpose of data communication, which may be utilized to communicatively couple various components of the environment 100. The network 108 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or a FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 108 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As used herein, the term “client device” refers to a computer, a laptop computer, a tablet computer, a portable computing device, a personal digital assistant (PDA), a handheld cellular phone, a mobile phone, a wireless telephone, a smart phone, a handheld device having wireless connection capability, or any other electronic device suitable for communicating data via the network 108.

The client devices 102 may be configured to browse web sites or access remote servers via the network 108. For example, the client devices 102 may be used to communicate with the data processing system 104. In some embodiments, the client devices 102 may comprise a browser 110 providing the ability to browse and interact with sites on the Internet. In yet more embodiments, the client devices 102 may embed ad hoc software (e.g., a mobile application 112 providing the ability to communicate with the data processing system 104).

Job seekers may use the client devices 102 to access the data processing system 104 for interactively creating the composite psychographic resumes online or for performing online job seeking. The data processing system 104 may be implemented as hardware, software, or a combination thereof to process user requests received via the network 108 and generate the requested content.

The data processing system 104 may comprise a resume creating system 114. The resume creating system 114 may be utilized for generating the composite psychographic resumes online and storing the composite psychographic resumes that have been generated in the database 118 in an applicable electronic format (e.g., a web page or a database table).

The data processing system 104 may also comprise a job seeking system 116. The job seeking system 116 may be utilized to perform online job seeking by prompting the job seekers to answer one or more questions to create skill-like matrices and calculating scores for a plurality of predetermined occupations to find the best fitting occupations and job openings currently present on the job market.

The web server 106 may be implemented as hardware, software, or a combination thereof, and may be utilized to deliver content to the users of the one or more client devices 102. In particular, the web server 106 may generate, customize, and host multiple web pages 120, which may be accessed via the network 108. In order to generate or customize the web pages 120, the web server 106 may access the data processing system 104 either via the network 108 or directly.

According to various embodiments disclosed herein, there can be provided multiple web servers 106 hosting various websites. For example, some additional web servers 106 (not shown) may host third party websites such as social media sites, which include social networking sites, blogs, e-mail servers, file exchangers, and other websites.

According to various embodiments disclosed herein, the data processing system 104 may provide a gateway to the web server 106 to enable the web server 106 to communicate to the data processing system 104 via a secure protocol. In addition, the web server 106 may provide access for the data processing system 104. The access can be provided via a corresponding API.

In some example embodiments, the web server 106 may be integrated with the data processing system 104. In some other example embodiments, the resume creating system 114, the job seeking system 116, the database 118, and the web server 106 may be remotely located from each other. Those skilled in the art would appreciate that any configuration of these system is possible, and also that some systems may be of any number.

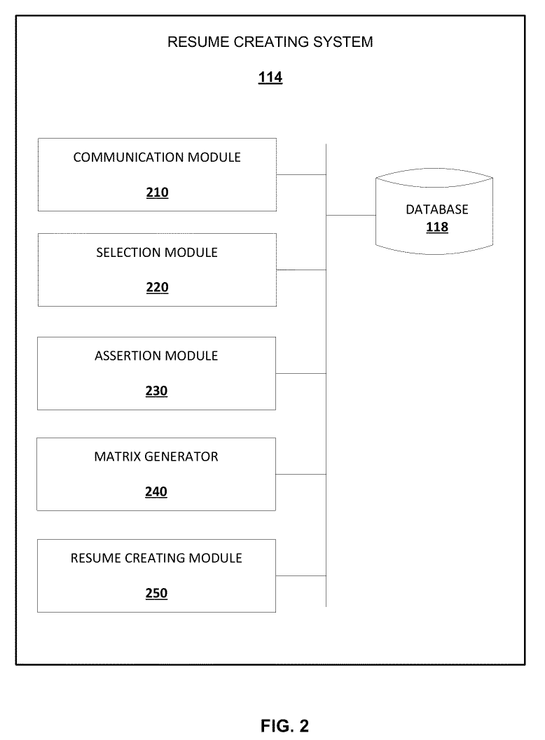

FIG. 2 is a diagram of the resume creating system 114, according to an example embodiment. In this embodiment, the resume creating system 114 may include a communication module 210, a selection module 220, an assertion module 230, a matrix generator 240, and a resume creating module 250. In other embodiments, the resume creating system 114 may include additional, fewer, or different modules for various applications. Furthermore, all modules may be integrated within a single apparatus, or, alternatively, may be remotely located and optionally be accessed via a third party.

The communication module 210 may be configured to receive user requests to create the one or more composite psychographic resumes. According to various embodiments, the composite psychographic resumes may be created online and on an interactive basis.

The communication module 210 may also be configured to transmit data between the one or more client devices 102 and the resume creating system 114, between the web server 106 and the resume creating system 114, and between the database 118 and the resume creating system 114.

The selection module 220 may be configured to prompt the users to select one or more job roles, add a name, an age, contact information, qualifications (e.g., information related to education and training such as academic degrees, names of schools, colleges, universities, or some other academic institutions, years of education, a GPA (grade point average), majors), and so forth. Optionally, the users may further be provided with predetermined questions related to their previous selections or inputs. For example, questions may prompt the users to describe why the users wish to apply for the selected job role, what the users like in this field, the qualities of an ideal employee, and so forth. The answers to such questions may be very helpful for to the recruiters. In addition, the recruiters may preliminarily customize such questions and a number of such questions.

Generally, the users may be prompted to input information upon a user request to create the composite psychographic resume. The information may either be selected from a predetermined list of answers and/or inputted by the users. For this purpose, the users may be provided with access to a web page 120 having, for example, one or more selectable options and/or input fields.

The assertion module 230 may be configured to prompt the user to input the one or more assertions associated with the one or more selected job roles and/or the predetermined skills and abilities of the user. The one or more assertions may comprise user skills, knowledge levels, and preference levels. The user skills may optionally be predetermined, and the users may be enabled to select one or more of such predetermined sets of skills. The skills associated with a specific job role may be based on the historical answers and selections. For example, if a user selects accounting as a desired job role, the user may be prompted to select one or more of the following skills: listening actively, thinking critically, communicating for impact, solving complex problems, reading, applying judgment, coordinating with others, learning proactively, monitoring results and performance, and so forth. The users may also be invited to evaluate a level of the selected skills of the user from low to high. In some embodiments, the skill level may have points (e.g., from 0 to 10).

In general, a user is prompted to select one or more of such skills, which may either be well known to the user or not. In some example embodiments, the user may not be able to select a skill that the user knows well until the user selects a skill the user does not know at all or knows poorly.

Furthermore, the user may be prompted to indicate the preference levels of the user related to each selected skill. Namely, the user may indicate what skills the user likes and/or dislikes. Similarly, the preference level may be provided in points (e.g., from 0 to 10). In some example embodiments, the user may not be able to select the skill that the user likes until the user selects a skill the user does not like.

Thus, when the user selects a plurality of skills, a two-dimensional data array or skill-like matrix may be generated. In such a data array, each line may be associated with a certain skill and comprise skill level points and preference level points. The matrix generator 240 may be configured to generate such matrices related to one or more selected assertions.

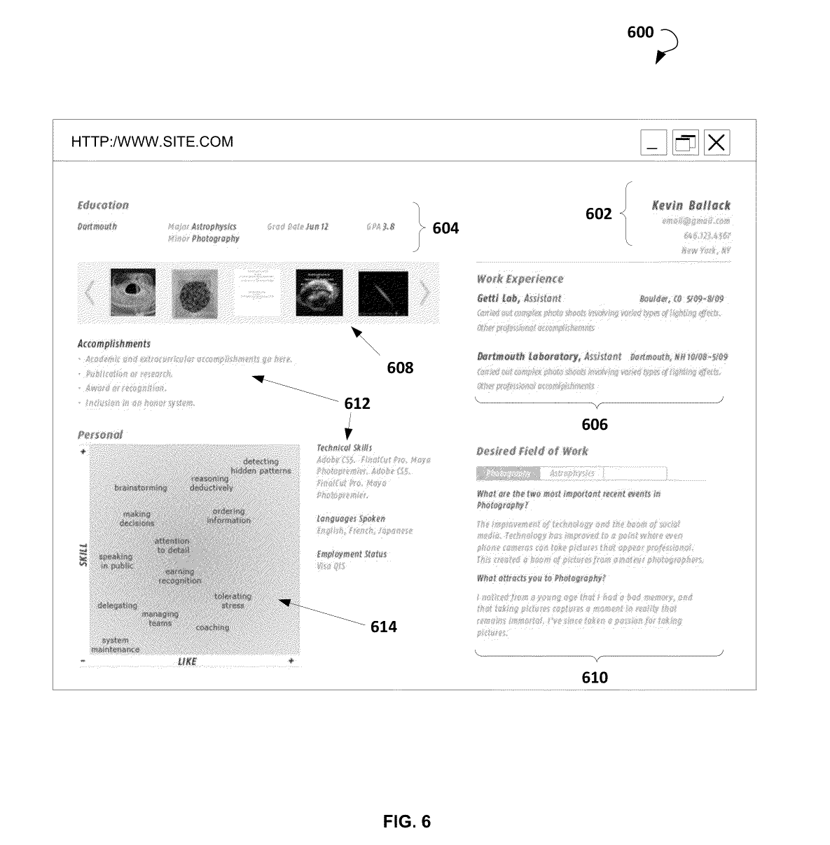

Visually, the skill-like matrix may be represented as a two-dimensional chart in which abscissa may represent the level of preference, while the axis of ordinates may represent the skill level. A particular example of such a skill-like matrix is shown in FIG. 6.

In some embodiments, the user may be provided with a web page or a widget presented via the web page for conveniently selecting the skills and corresponding levels. More specifically, the user may be initially provided with an empty two-dimensional chart and a list of possible skills. The user may then drag the skills from the list to the chart and position the skills as appropriate. The assertion module 230 may then determine what skill level points and preference level points are associated with the position of the skill on the chart.

The resume creating module 250 may be configured to create the resume based on all user inputs and selections. The resume may be presented as an electronic document such as a web page. The resume may comprise all inputted and selected information as well as the “skill-like” matrix. The resume may then be displayed through the client devices 102.

The database 118 may be configured to store the created composite psychographic resumes, information selected or inputted by the user, the skill-like matrices, predetermined questions and selectable elements, and so forth.

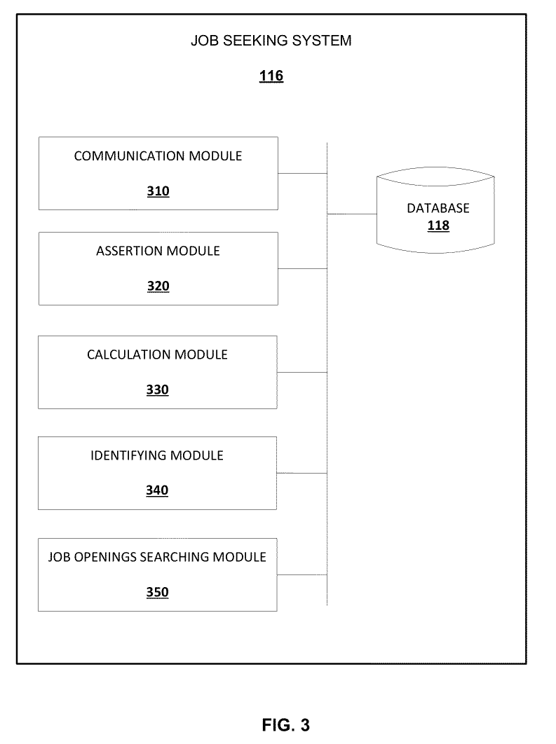

FIG. 3 is a diagram of the job seeking system 116, according to an example embodiment. In this embodiment, the job seeking system 116 may include a communication module 310, an assertion module 320, a calculation module 330, an identifying module 340, and a job openings searching module 350. In other embodiments, the job seeking system 116 may include additional, fewer, or different modules for various applications. Furthermore, all modules may be integrated within a single apparatus, or, alternatively, may be remotely located and optionally be accessed via a third party.

The communication module 310 may be configured to receive user requests to perform online job seeking. According to various embodiments, the user request may comprise one or more of a desired work field, user education information, user employment history, and so forth. The user request may also include user credentials such as login and password, which can be further used to create a user profile within the data processing system 104.

The communication module 310 may also be configured to transmit data between the one or more client devices 102 and the job seeking system 116, between the web server 106 and the job seeking system 116, between the database 118 and the job seeking system 116, and between job seeking system 116 and the resume creating system 114.

The assertion module 320 may be configured to prompt the user to input the one or more assertions associated with the user preferences with respect to one or more work activities and one or more work styles. The one or more assertions may comprise user skills, knowledge levels, and preference levels. The work activities may optionally be predetermined, and the users may be enabled to select the one or more of such predetermined sets of work activities and rate how good they are at doing such activities and how well they like such activities. The same is true with respect to work styles; specifically, the work styles can be predetermined, and the users may be enabled to select the one or more of such predetermined work styles and rate how good they are at performing such work styles and how well they like such work styles. The work styles and work activities associated with a specific user request may be based on the historical answers and selections. For example, if a user selects accounting as a desired work field, the user may be prompted to select one or more of the following work activities: technical documentation, quality control, programming, financial resource management, mathematical reasoning, data entry, computer literacy, visualization, analytical thinking, attention to detail, dependability, directing others learning new things, patience, seeing the big picture, selling, and so forth. The users may also be invited to evaluate a level of the selected skills, abilities, work activities, and work styles of the user from low to high. In some embodiments, the levels may have points (e.g., from 0 to 10). The evaluation process may include placing graphical representations associated with the work styles and work activities at the two-dimensional chart related to the skill-like matrix. In other words, the user is prompted to indicate the preference levels for every selected work activity and work style. Namely, the user may indicate which skills, abilities, work activities, and work styles the user likes and/or dislikes. Similarly, the preference level may be provided in points (e.g., from 0 to 10).

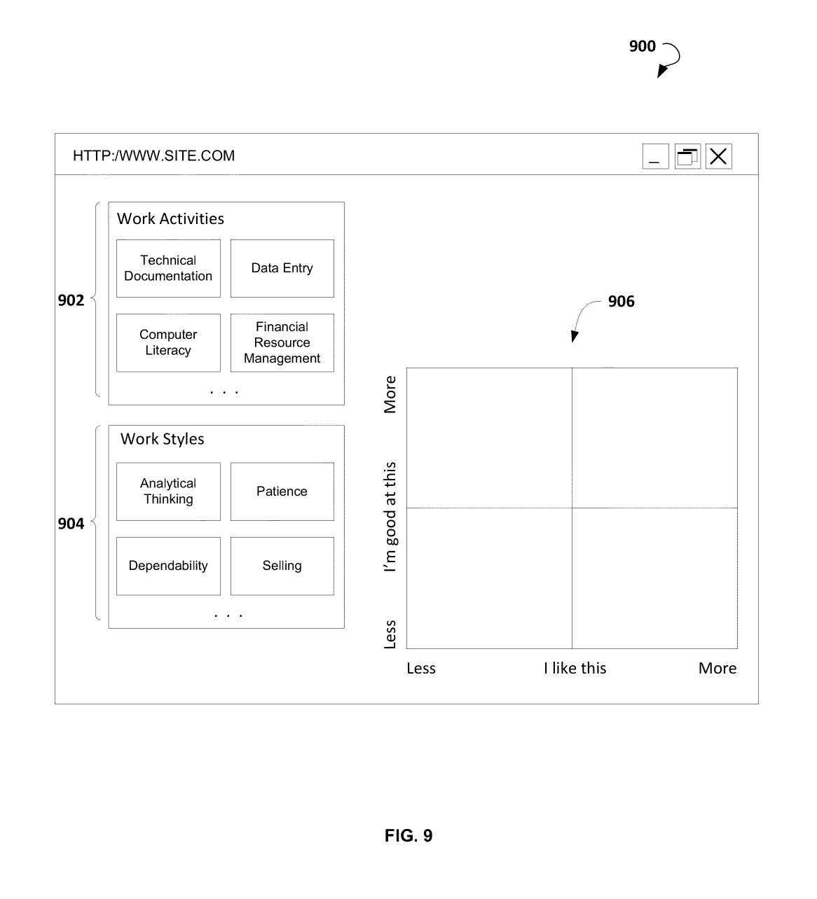

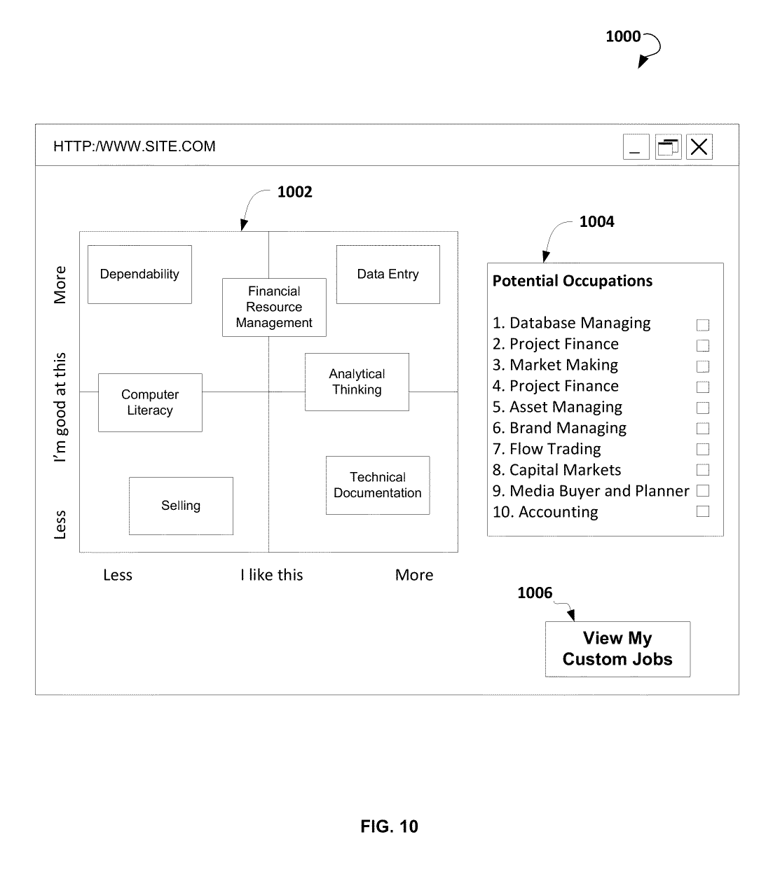

Thus, when the user selects a plurality of work styles and life styles, a two-dimensional data array or skill-like matrix may be generated. In such a data array, each line may be associated with a certain skill and comprise skill level points and preference level points. As mentioned, the skill-like matrix may be represented visually as a two-dimensional chart in which abscissa may represent the level of preference, while the axis of ordinates may represent the skill level. A particular example of such a skill-like matrix is shown in FIGS. 9 and 10.

In some embodiments, the user may be provided with a web page or a widget presented via the web page for conveniently selecting the work styles, life styles and their corresponding levels. More specifically, the user may be initially provided with an empty two-dimensional chart and a list of possible skills. The user may then drag the work styles and life styles from the list to the chart and position the skills as appropriate. The assertion module 320 may then determine what skill level points and preference level points are associated with the position of the skill on the chart.

The calculation module 330 may be configured to calculate scores associated with a plurality of predetermined occupations based on one or more of the following: the user request, one or more assertions, and the skill-like matrix. The scores represent how the user fits every predetermined occupation. The predetermined occupations may include nearly all possible occupations including, for example, banking, accounting, the legal field, engineering, management, medicine, business, science, and so forth.

In an embodiment, the calculation module 330 can calculate the scores by retrieving a predetermined set of work activities, work styles, and their rankings related to each predetermined occupations. Further, the one or more assertions inputted by the user are compared with the predetermined set of work activities, work styles, and their rankings. At the next step, differences or corresponding derivatives of the differences are determined between the one or more assertions and the predetermined set of work activities, work styles, and their rankings related to each predetermined occupation. Finally, the scores are calculated based on the determined differences. Those skilled in the art will understand that other suitable ways to calculate scores can be utilized.

The identifying module 340 may be configured to selectively identify a list of predetermined occupations as the most favorable for the user. In an embodiment, a predetermined occupation is the user when the score associated with the predetermined occupation is higher (lower) than scores associated with other predetermined occupations. Accordingly, a predetermined number of occupations having the highest or lowest scores can be selected to build a list of predetermined occupations as the most favorable for the user. In an example, this list may include ten predetermined occupations, which are then presented to the user. When the list of predetermined occupations being the most favorable for the user is generated, the identifying module 340 can compare the scores of each occupation to a predetermined value and then select those occupations whose associated score is above (below) the predetermined value.

The job openings searching module 350 may be configured to prompt the user to select one or more predetermined occupations from the list of occupations being the most favorable for the user. Once at least one predetermined occupation from the list of occupations being the most favorable for the user is selected, the job openings searching module 350 may selectively provide a list of job openings associated with the selected one or more predetermined occupations. The job openings can be retrieved from a third party database, a third party web server 106, or the database 118. The user can then apply for any desired job opening by submitting a resume, sending email, or any other suitable way of communication.

The resume creating module 250 may be configured to create the resume based on all user inputs and selections. The resume may be presented as an electronic document such as a web page. The resume may comprise all inputted and selected information as well as the “skill-like” matrix. The resume may then be displayed through the client devices 102. In some embodiments, the resume may be used for job openings selection by comparing the resume information and descriptions of job openings.

According to various embodiments, the user can be prompted to provide additional information including a name, an age, contact information, photo, qualifications (e.g., information related to education and training such as academic degrees, names of schools, colleges, universities, or some other academic institutions, years of education, a GPA, majors, etc.), working experience, trainings, awards, honors, and so forth. Optionally, the users may further be provided with predetermined questions related to their previous selections or inputs. For example, questions may prompt the users to describe what the ideal job role is for them, why the users wish to apply for certain job roles, what the users like in this field, the qualities of an ideal employee, and so forth. The answers to such questions may be very helpful to the recruiters. In addition, the recruiters may preliminarily customize such questions and the number of such questions. In addition, the users can be prompted to upload their works (i.e., portfolio) and any other suitable information. Generally, the information provided by the users may be utilized to create the composite psychographic resume and, optionally, a user profile. The resume creating system 114 can be responsible for creating the composite psychographic resumes.

According to various embodiments, the resume creating system 114 (or, alternatively, the job seeking system 116) can facilitate automatically providing information required for the composite psychographic resumes. In particular, the resume creating system 114 (or, alternatively, the job seeking system 116) can be configured to access a social media site, find a profile of the user, and then download the profile of the user or retrieve particular information of the profile. More specifically, the imported (retrieved) information may include user education, user experience, user personal information, user connections, and so forth. This information can be used for automatically creating the psychographic resume of the user.

According to various embodiments, the job seeking system 116 can also access the third party site, such as a social media site, to identify one or more user connections (e.g., “friends”) of the social media site. Further, the job seeking system 116 can identify those user connections who are associated with the list of job openings found by the job openings searching module 350. Once such connections are identified, they are provided to the user.

According to various embodiments, the resume creating system 114 can be also configured to generate one or more graphical timelines defining the time periods associated with periods of time when the user was employed and/or in college. The graphical timelines can be presented as a two-dimensional chart in which abscissa represents the details of education and working experience (e.g., names, titles, job roles, university names, company names, etc.), while the axis of ordinates represents the time. The bars can be shown in such a two-dimensional chart to demonstrate time periods when the user was attending a particular school or college/university, or when he worked for a particular company. The graphical timelines can be also used in the psychographic resumes.

It should be also mentioned that the skill-like matrix and, thus, the list of predetermined occupations being the most favorable for the user and job openings pertaining to those occupations, can be dynamically generated and presented to the user once the user adds additional information to his profile or psychographic resume.

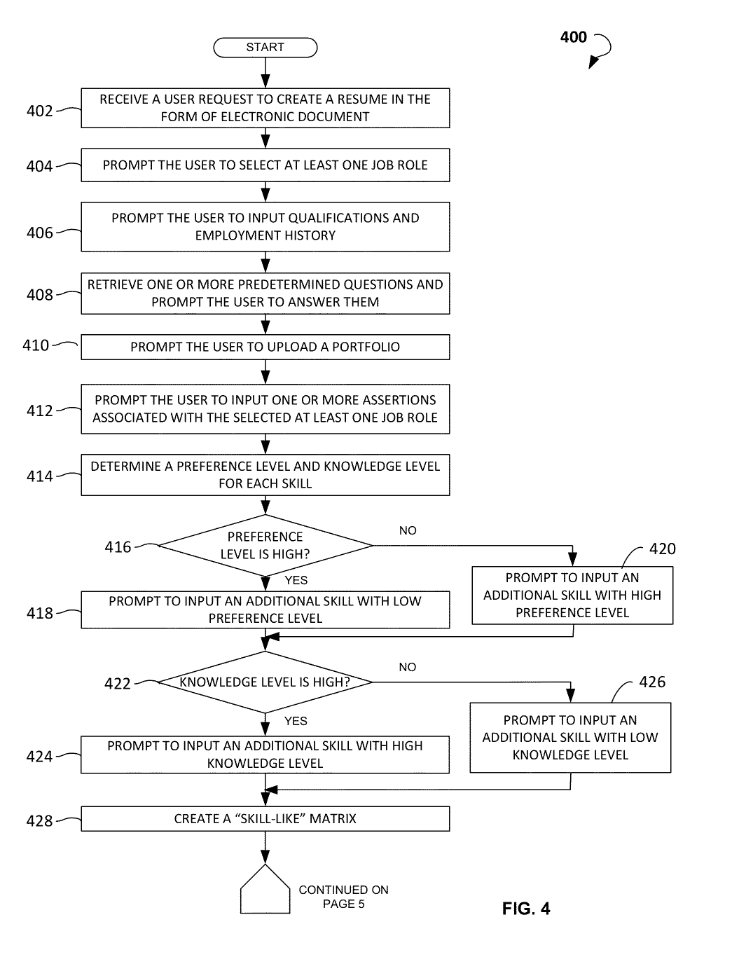

FIG. 4 is a process flow diagram showing a method 400 for creating the composite psychographic resume, according to an example embodiment. The method 400 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the resume creating system 114, and the various modules of the resume creating system 114 may perform the method 400. Each of these modules may comprise the processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

As shown in FIG. 4, the method 400 may commence at operation 402 with the communication module 210 receiving the user request to create the composite psychographic resume in the form of an electronic document. The user request may be generated and sent via the client device 102 by visiting a certain web page 120.

At operation 404, the selection module 220 may prompt the user to select the at least one job role (e.g., accountant, astrophysics researcher, photographer, etc.). To select such job roles, the user may be provided with a selection menu, drop-down menu, or any other widget through a certain web page 120 visited by the user.

At operation 406, the selection module 220 may further prompt the user to input user qualifications and employment history. The user may further (and optionally) be prompted to input a name, age, contact information, references, and so forth. The qualifications of the user may include various data related to prior education and training, including: the names of academic institutions (colleges, schools, and universities), years of education or years of graduation, GPAs, obtained degrees, majors, and so forth.

At operation 408, the selection module 220 may retrieve one or more predetermined questions from the database 118 and prompt the user to answer the one or more predetermined questions. Such predetermined questions may be associated with the one or more selected jobs, and may include, for example, the following questions: “What would be your ideal job in accounting?”, “What attracts you to it?”, “What skills have you developed that would make you an ideal candidate?” and so forth.

At operation 410, the selection module 220 may optionally prompt the user to upload the portfolio of works of the user. The portfolio may generally relate to a collection of artworks intended to showcase an artist's style and method of work. The portfolio may comprise photos, pictures, audio- and video content, texts, articles, web pages, or some other electronic documents for reviewing by potential recruiters or employers. All inputs may be stored in the database 118.

At operation 412, the assertion module 230 may prompt the user to input the one or more assertions associated with the selected at least one job role. The one or more assertions may relate to user skills, knowledge levels, and preference levels. In general, the skills may relate to any ability and capability of the user to acquire skills through deliberate, systematic, and sustained effort to smoothly and adaptively carry out complex activities or job functions involving ideas (cognitive skills), things (technical skills), and/or people (interpersonal skills). Some examples of skills may include, but not be limited to: “Listening actively,” “Thinking critically,” “Communicating for impact,” “Solving complex problems,” “Reading,” “Applying judgment,” “Coordinating with others,” “Learning proactively,” “Monitoring results and performance,” “Analyzing operations,” “Thinking through your eyes,” “Seeing details,” “Brainstorming,” “Applying originality,” “Sensing something is wrong,” and “Reasoning deductively.”

The user may be prompted to indicate the knowledge level of the user for each selected skill. For example, the knowledge level may be represented by a point number (e.g., between 0 and 10, where 10 states that the user knows a certain skill on the highest level).

In some embodiments, the user may be prompted to indicate the knowledge level for the one or more skills one by one without taking into account interrelations between indicated knowledge levels of the one or more skills. In other embodiments, when the knowledge level is high, the user may be prompted to input an additional skill with a low knowledge level, while when the knowledge level is low, the user may be prompted to input an additional skill with a high knowledge level. The user may be also prompted to indicate a preference level (“like”) for each selected skill. For example, the preference level may be represented by a point number (e.g., between 0 and 10, where 10 states that the user likes a certain skill on the highest level, and where 0 means that the user does not like the skill). When the preference level is high, the user may be prompted to input an additional skill with a low preference level, while when the preference level is low, the user may be prompted to input an additional skill with a high preference level.

In some particular example embodiments, the assertion module 230 may not allow the user to input certain level values, but may allow dragging assertions (skills) to a two-dimensional chart with the help of a graphical user interface. If this is the case, the assertion module 230 may automatically determine a preference level and knowledge level for each dragged assertion from the two-dimensional chart.

Either way, at operation 414, the assertion module 230 may determine a preference level and knowledge level for each skill inputted by the user.

At operation 416, it is determined whether the preference level related to each skill is high (e.g., above 5, if the entire scale is between 0 and 10 points). If the preference level is high, the user may be prompted, at operation 418, to input an additional skill with a low preference level. Alternatively, when the preference level is low, the user may be prompted, at operation 420, to input an additional skill with a high preference level.

At operation 422, it is determined whether the knowledge level related to each skill is high or low. If the knowledge level is high, the user may be prompted, at operation 424, to input an additional skill with a low knowledge level. Alternatively, when the knowledge level is low, the user may be prompted, at operation 426, to input an additional skill with a high knowledge level. Operations 414-426 may be optional.

At operation 428, the matrix generator 240 may create the skill-like matrix (i.e., a two-dimensional data array) consisting of the inputted one or more assertions. In other words, the skill-like matrix may consist of inputted user skills, knowledge levels, and preference levels. At the same operation 428, the skill-like matrix may be optionally stored in the database 118.

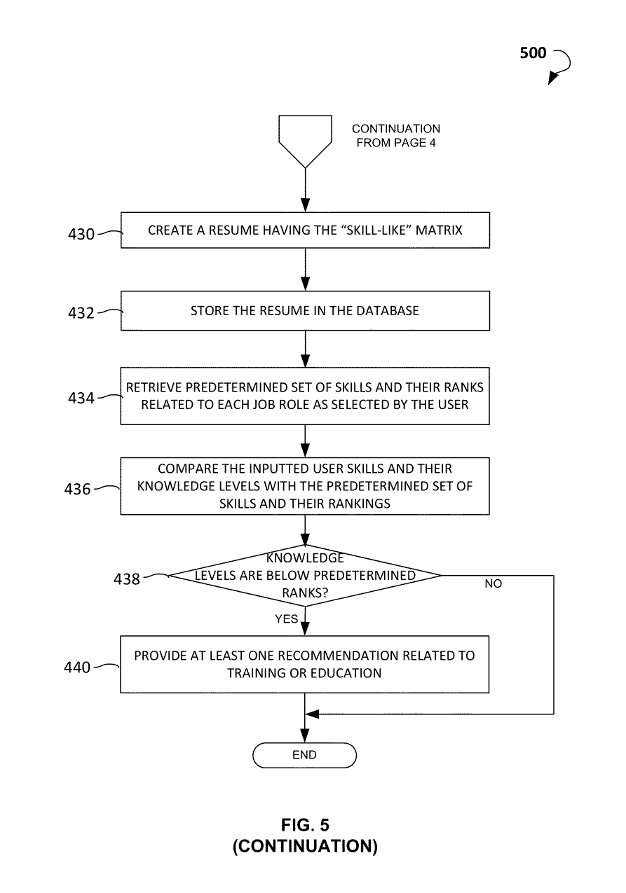

FIG. 5 is a process flow diagram showing a method 500 for creating composite psychographic resumes, according to an example embodiment (continued from FIG. 4).

At operation 430, the resume creating module 250 may create a composite psychographic resume related to the user for the selected one or more job roles. The resume may be generated as an electronic document (e.g., a web page 120 and, more particularly, an interactive web page 120). One particular example of the generated resume is shown in FIG. 6.

The resume may comprise one or more of personal data (name, age, and contact information), work fields (e.g., desired job roles), qualifications, employment history, answers to certain predetermined questions, and a portfolio of works. According to the embodiments, each composite psychographic resume may also be accompanied with the one or more assertions presented, for instance, in the form of the two-dimensional chart.

At operation 432, the resume may be stored in the database 118 for further accessing by the job applicant or recruiters. In some examples, the resume may comprise a unique identification, such as an URL (Uniform Resource Locator), and may be accessed via the network 108.

At operation 434, a predetermined set of skills and abilities and related rankings related to each job role selected by the user may be retrieved from the database 118. For example, if the user selected a desired job role in accounting, the predetermined skills most meaningful for the accounting job role are retrieved from the database 118.

At operation 436, the inputted user skills and knowledge levels may be compared with the predetermined set of skills and related rankings.

At operation 438, differences between the knowledge level for each selected skill and the rankings of the predetermined set of skills and abilities may be determined to calculate the score. The score may be representative of how the user (i.e., the job applicant) is fitted to the job role. In some embodiments, based on the score, job roles may be recommended, while in other embodiments, overall rankings of the predetermined skills and abilities may be used as a candidate eligibility threshold. For example, if it is determined that the skill knowledge levels of the user are higher (or lower) than the rankings (i.e., minimum acceptable levels), the user may be considered as an eligible candidate.

Alternatively, when the knowledge levels are below the predetermined rankings, the user may be considered as ineligible for the selected job role. If this is the case, at operation 440, the user may be provided with at least one recommendation. The recommendation may relate to taking certain classes or training so that the user may improve certain skills, applying for a certain job role that is different from the selected job role, and so forth. For example, when the user selected a job role as an “assurance manager,” and it was determined that the user does not have sufficient skills or the levels of the user's skills are below a permissible minimum, the user may be provided with a recommendation to apply for “assurance assistant,” or to take a certain training program or classes to improve the one or more skills of the user.

FIG. 6 is a simplified illustration of a graphical user interface 600 of a web page 120 representing the composite psychographic resume, according to an example embodiment. The graphical user interface 600 may be represented as a window (e.g., a browser window) to show its content. In one example, the graphical user interface 600 may be shown on a screen of the client device 102 via the browser 110.

By way of example and not limitation, the graphical user interface 600 shows the composite psychographic resume created with the method as described above with reference to FIGS. 4-5. The graphical user interface 600 may comprise a section 602 to define personal data (a job applicant name, contact information), a section 604 to indicate job applicant qualifications (for example, education details such as a university name, major, graduation date, and GPA), a section 606 to indicate the employment history, a section 608 to indicate the portfolio of works (for example, pictures, photos, videos, science articles, and so forth), a section 610 to indicate answers to the predetermined questions, a section 612 to indicate additional information (such as accomplishments, technical skills, languages spoken, employment status, and so forth), and a section 614 to show the skill-like matrix in the form of the two-dimensional chart.

The sections 602 to 614 may be represented as widgets that relate to one or more of actionable buttons, selectable options, cycle buttons, controls, icons, hyperlinks, text boxes, list boxes, check boxes, images, videos, and the like.

Those skilled in the art would appreciate that the graphical user interface 600 may include additional, fewer, or different sections depending on the application.

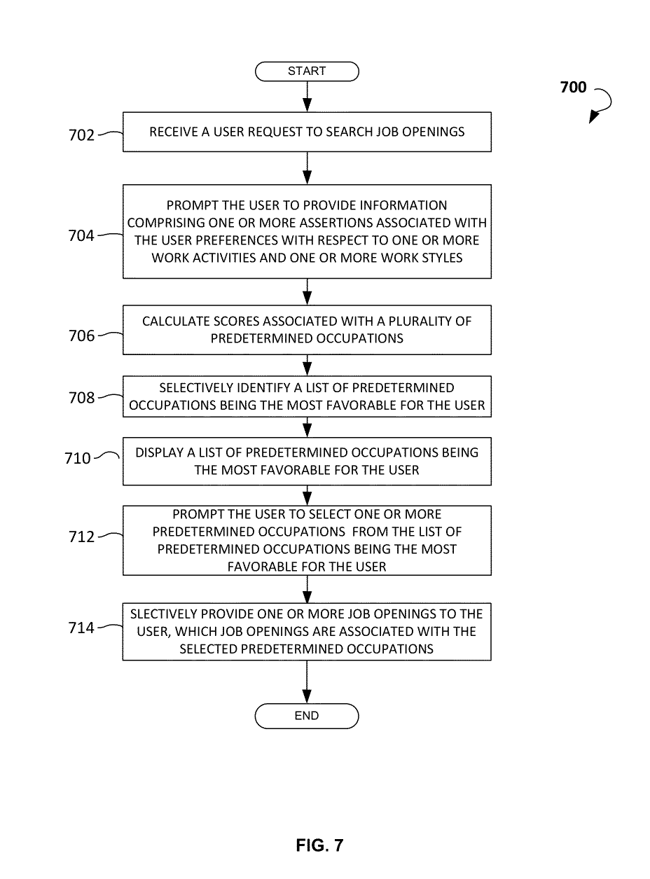

FIG. 7 is a process flow diagram showing a method 700 for job seeking, according to an example embodiment. The method 700 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the job seeking system 116 and the various modules of the job seeking system 116 may perform the method 700. Each of these modules may comprise the processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

As shown in FIG. 7, the method 700 may commence at operation 702 with the communication module 310 receiving the user request to search job openings. The user request may include a desired work field and optionally user education information, user work experience, user credentials, and so forth. The user request may be generated and sent via the client device 102 by visiting a certain web page 120 or via the mobile application 112.

At operation 704, the assertion module 320 may prompt the user to provide information comprising one or more assertions associated with the user preferences with respect to one or more work activities and one or more work styles. The work activities may optionally be predetermined, and the users may be enabled to select the one or more of such predetermined sets of work activities and rate how good they are at doing such activities and how they like such activities. Similarly, the work styles can be also predetermined and the users may be enabled to select the one or more of such predetermined work styles and rate how good they are at performing such work styles and how they like such work styles. The work styles and work activities associated with a specific user request may be based on the historical answers and selections. For example, if a user selects accounting as a desired work field, the user may be prompted to select one or more of the following work activities: technical documentation, quality control, programming, financial resource management, mathematical reasoning, data entry, computer literacy, visualization, analytical thinking, attention to detail, dependability, directing others learning new things, patience, seeing the big picture, selling, and so forth. The users may also be invited to evaluate a level of the selected skills, abilities, work activities, and work styles of the user from low to high. In some embodiments, the levels may have points (e.g., from 0 to 10). The evaluation process may include placing graphical representations associated with the work styles and work activities at the two-dimensional chart related to the skill-like matrix. In other words, the user is prompted to indicate the preference levels for every selected work activity and work style. Namely, the user may indicate which skills, abilities, work activities, and work styles the user likes and/or dislikes. Similarly, the preference level may be provided in points (e.g., from 0 to 10). Thus, when the user selects a plurality of work styles and life styles, a two-dimensional data array or skill-like matrix may be generated. In such a data array, each line may be associated with a certain skill and comprise skill level points and preference level points. As mentioned, the skill-like matrix may be visually represented as a two-dimensional chart in which the abscissa may represent the level of preference, while the axis of ordinates may represent the skill level. A particular example of such a skill-like matrix is shown in FIGS. 9 and 10.

At operation 706, the calculation module 330 calculates scores associated with a plurality of predetermined occupations. The calculating is based on the user request and the information provided by the user at operations 702 and/or 704. As mentioned, the scores identify how the user is favorable for every predetermined occupation.

In an example embodiment, the scores can be calculated by the calculation module 330 by retrieving a predetermined set of work activities, work styles, and their rankings related to each predetermined occupations. Further, the one or more assertions inputted by the user are compared with the predetermined set of work activities, work styles, and their rankings. At the next step, differences are determined between the one or more assertions and the predetermined set of work activities, work styles, and their rankings related to each predetermined occupation. Finally, the scores are calculated based on the determined differences. Those skilled in the art will understand that other suitable ways to calculate scores can be utilized.

At operation 708, the identifying module 340 selectively identifies a list of predetermined occupations being the most favorable for the user. At operation 710, the list of predetermined occupations being the most favorable for the user are presented to the user via the browser 110 or mobile application 112. As was discussed above, a predetermined occupation is more favorable for the user when the score associated with the predetermined occupation is higher (lower) than scores associated with other predetermined occupations. Accordingly, a predetermined number of predetermined occupations having the highest scores can be selected to build a list of predetermined occupations being the most favorable for the user. In an example, this list may include ten predetermined occupations which are then presented to the user. When the list of predetermined occupations being the most favorable for the user is generated, the identifying module 340 can compare the scores of each occupation to a predetermined value and then select those occupations whose associated score is above (below) the predetermined value.

At operation 712, the job openings searching module 350 prompts the user to select one or more predetermined occupations from the list of occupations being the most favorable for the user. Once at least one predetermined occupation from the list of occupations being the most favorable for the user is selected, at operation 714, the job openings searching module 350 selectively provides (displays) a list of job openings associated with the selected one or more predetermined occupations. The job openings can be retrieved from a third party database, a third party web server 106, or the database 118. The user then can apply for any desired job opening by submitting resume, sending email, or any other suitable way of communication.

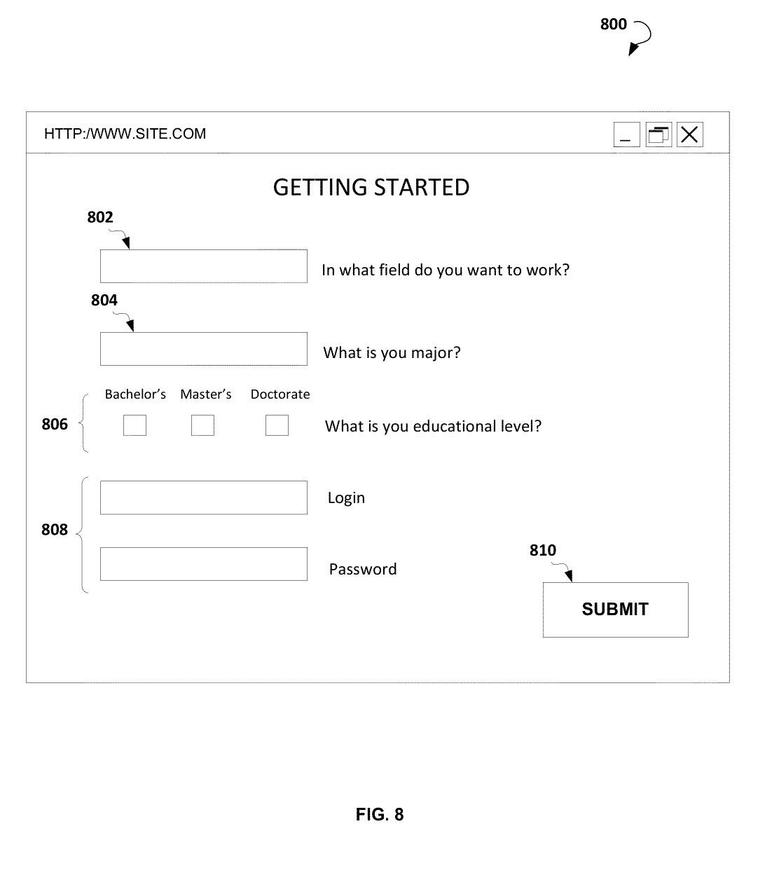

FIG. 8 is a simplified illustration of a graphical user interface 800 of a web page 120 suitable for generating a user request, according to an example embodiment. The graphical user interface 800 may be represented as a window (e.g., a browser window) to show its content. In one example, the graphical user interface 800 may be shown on a screen of the client device 102 via the browser 110.

By way of example and not limitation, the graphical user interface 800 may comprise a section 802 to input a desired work field (occupation), a section 804 to input education information of the user such as a user's college, and a section 806 to select the user's level of education (i.e., Bachelor's degree, Master's degree, and Doctorate degree). The graphical user interface 800 may also include a section 808 to input user credentials such as an email (login) and password. The graphical user interface 800 may also include a clickable button 810 “Submit” to initiate the process of job seeking by the job seeking system 116.

The sections 802 to 810 may be represented as widgets that relate to one or more of actionable buttons, selectable options, cycle buttons, controls, icons, hyperlinks, text boxes, list boxes, check boxes, images, videos, and the like. Those skilled in the art would appreciate that the graphical user interface 800 may include additional, fewer, or different sections depending on the application.

FIG. 9 is a simplified illustration of a graphical user interface 900 of a web page 120 suitable for generating a skill-like matrix, according to an example embodiment. The graphical user interface 900 may be represented as a window (e.g., a browser window) to show its content. In one example, the graphical user interface 900 may be shown on a screen of the client device 102 via the browser 110.

By way of example and not limitation, the graphical user interface 900 may comprise a section 902 having a plurality of blocks pertaining to various work activities, a section 904 having a plurality of blocks pertaining to various work styles, and a section 906 representing the skill-like matrix. The user can be enabled to drag the blocks pertaining to various work activities and the blocks pertaining to various work styles and place them in appropriate locations on the skill-like matrix. As shown, the skill-like matrix is a two-dimensional chart in which abscissa represents the level of preference, while the axis of ordinates may represent the skill level. In other words, initially, the skill-like matrix is empty, and the user can drag one or more blocks from the sections 902 and 904 to appropriate locations on the skill matrix. An example result of such dragging is shown in FIG. 10.

The sections 902 to 906 may be represented as widgets that relate to one or more of actionable buttons, selectable options, cycle buttons, controls, icons, hyperlinks, text boxes, list boxes, check boxes, images, videos, and the like. Those skilled in the art would appreciate that the graphical user interface 900 may include additional, fewer, or different sections depending on the application.

FIG. 10 is a simplified illustration of a graphical user interface 1000 of a web page 120 suitable for providing and selecting one or more predetermined occupations, according to an example embodiment. The graphical user interface 1000 may be represented as a window (e.g., a browser window) to show its content. In one example, the graphical user interface 1000 may be shown on a screen of the client device 102 via the browser 110.

By way of example and not limitation, the graphical user interface 1000 may comprise a section 1002 showing an example of a completed out skill-matrix (i.e., the skill-matrix with blocks associated with various skills, abilities, work activities, and work styles as placed by the user). The graphical user interface 1000 may also comprise a section 1004 providing a list of predetermined occupations being the most favorable for the user as determined by the job seeking system 116 as described above with reference to FIG. 8. The user is enabled to select one or more of the provided predetermined occupations being the most favorable for the user.

The graphical user interface 1000 may comprise a clickable button 1006 “View My Custom Jobs” which can initiate retrieving of the job openings associated with the selected predetermined occupations.

The sections 1002 to 1006 may be represented as widgets that relate to one or more of actionable buttons, selectable options, cycle buttons, controls, icons, hyperlinks, text boxes, list boxes, check boxes, images, videos, and the like. Those skilled in the art would appreciate that the graphical user interface 1000 may include additional, fewer, or different sections depending on the application.

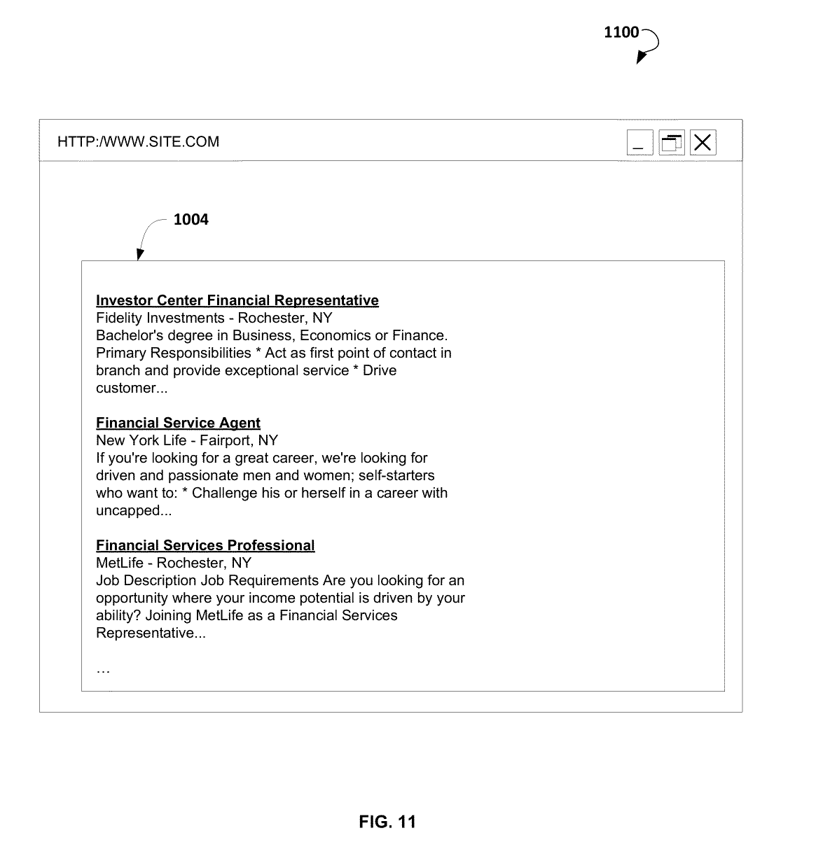

FIG. 11 is a simplified illustration of a graphical user interface 1100 of a web page 120 suitable for providing a list of job openings, according to an example embodiment. The graphical user interface 1100 may be represented as a window (e.g., a browser window) to show its content. In one example, the graphical user interface 1100 may be shown on a screen of the client device 102 via the browser 110.

By way of example and not limitation, the graphical user interface 1100 may comprise a section 1102 showing a list of job openings retrieved from the database 118 or one or more third party websites or third party web servers 106. The list of job openings is associated with the selected predetermined occupations presented in the graphical user interface 1000 shown in FIG. 10. The user is then prompted to click one or more job openings from the section 1102 to read details of the job openings and apply for the job or in some other way communicate with the job openings poster.

The section 1102 may be represented as a widget that relate to one or more of actionable buttons, selectable options, cycle buttons, controls, icons, hyperlinks, text boxes, list boxes, check boxes, images, videos, and the like. Those skilled in the art would appreciate that the graphical user interface 1100 may include additional, fewer, or different sections depending on the application.

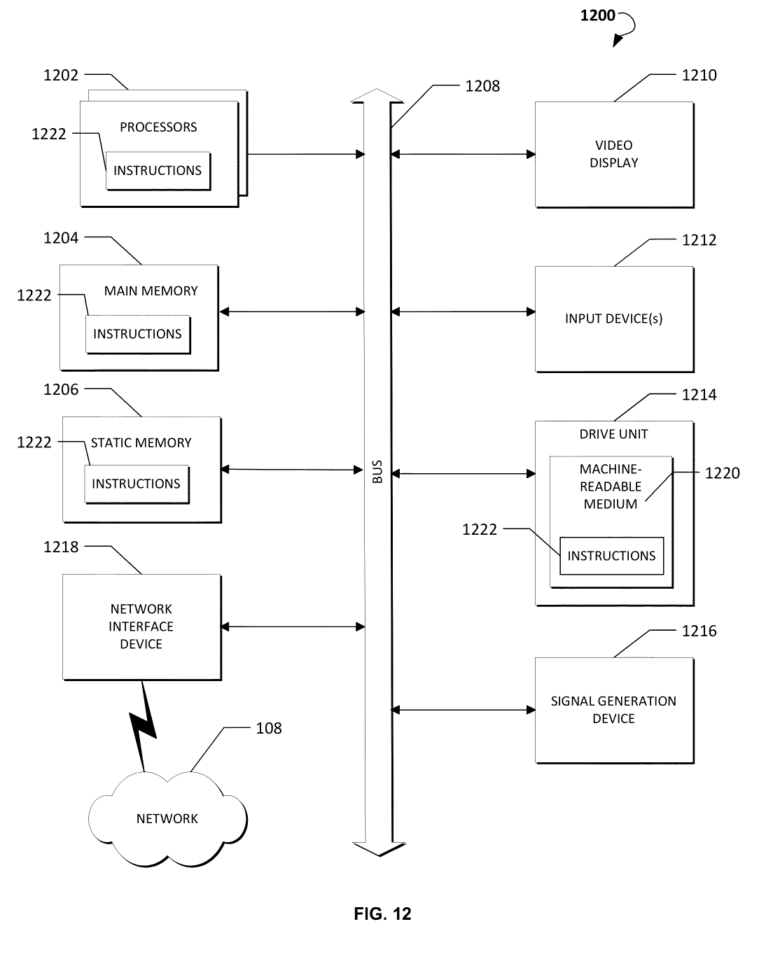

FIG. 12 shows a diagrammatic representation of a computing device for a machine in the example electronic form of a computer system 1200, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor or multiple processors 1202 (e.g., a central processing unit (CPU), a graphics processing unit (GPU), or both), and a main memory 1204 and a static memory 1206, which communicate with each other via a bus 1208. The computer system 1200 can further include a video display unit 1210 (e.g., a liquid crystal display (LCD) or a cathode ray tube (CRT)). The computer system 1200 also includes at least one input device 1212, such as an alphanumeric input device (e.g., a keyboard), a cursor control device (e.g., a mouse), a microphone, a digital camera, a video camera, and so forth. The computer system 1200 also includes a disk drive unit 1214, a signal generation device 1216 (e.g., a speaker), and a network interface device 1218.

The disk drive unit 1214 includes a computer-readable medium 1220, which stores one or more sets of instructions and data structures (e.g., instructions 1222) embodying or utilized by any one or more of the methodologies or functions described herein. The instructions 1222 can also reside, completely or at least partially, within the main memory 1204 and/or within the processors 1202 during execution thereof by the computer system 1200. The main memory 1204 and the processors 1202 also constitute machine-readable media.

The instructions 1222 can further be transmitted or received over the network 108 via the network interface device 1218 utilizing any one of a number of well-known transfer protocols (e.g., Hyper Text Transfer Protocol (HTTP), CAN, Serial, and Modbus).

While the computer-readable medium 1220 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, computer-implemented methods and systems for creating composite psychographic resumes having skill-like matrices are described. Also described are computer-implemented methods and systems for job seeking. The skill-like matrices generally provide more information and a better understanding of job applicants than conventional resumes. The simple visual representation of the skill-like matrices in the form of two-dimensional charts makes it simple to understand the skills and personality traits of the job applicant in a quick and convenient way. Generally, it was shown that reviewing the composite psychographic resumes having skill-like matrices is fast and informative. Furthermore, the job applicants may also find it easier to build the composite psychographic resumes with a visual representation of skills and traits of the job applicants in the form of the skill-like matrices. Such matrices are compact while also providing a great deal of information. In addition, it is worth mentioning that the skill-like matrices may be individualized for each job applicant, and, thus may be considered as a way of customizing applicant identification.

Although the embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for job seeking, the method comprising:
receiving, from a user, a user request to search job openings, wherein the user request comprises a desired work field and user education information;
based on the user request, prompting the user to provide information comprising one or more assertions associated with user preferences with respect to one or more work activities and one or more work styles, wherein the work activities include skills and abilities of the user;
based on the user request and the information, calculating scores associated with a plurality of predetermined occupations, wherein the scores identify how the user is favorable for every predetermined occupation; and
selectively identifying a list of predetermined occupations being the most favorable for the user.

2. The method of claim 1, further comprising:
prompting the user to select one or more predetermined occupations from the list of occupations being the most favorable for the user; and
selectively providing a list of job openings associated with the selected one or more predetermined occupations.

3. The method of claim 2, further comprising:
accessing a social media site to retrieve a profile of the user;
comparing one or more user connections of the profile with other profiles associated with the social media site; and
identifying those user connections that are associated with the list of job openings; and
providing information associated with the user connections to the user.

4. The method of claim 1, wherein a predetermined occupation is more favorable for the user when the score associated with the predetermined occupation is higher or lower than scores associated with other predetermined occupations.

5. The method of claim 1, wherein the selectively identifying the list of predetermined occupations being the most favorable for the user includes selecting a predetermined number of predetermined occupations having the highest or lowest scores.

6. The method of claim 1, further comprising:
based on the user request, creating a psychographic resume of the user in a form of an electronic document.

7. The method of claim 6, further comprising:
prompting the user to provide information comprising: a description of a job that the user perceives as optimal, user preferences, user education, and user experience; and
wherein creating the psychographic resume of the user is based on the provided information.

8. The method of claim 6, wherein the provided list of job openings is based on one or more of the following: a resume of the user, the psychographic resume of the user, matching of the resume of the user and one or more descriptions of the job openings, matching of the psychographic resume of the user and the one or more description of the job openings.

9. The method of claim 6, further comprising:
importing a profile of the user from a social media site, wherein the profile of the user comprises information including one or more of the following: user education, user work history, and user personal information; and
wherein creating the psychographic resume of the user is based on the profile of the user.

10. The method of claim 6, further comprising:
prompting the user to upload a user portfolio; and
updating the psychographic resume with the portfolio.

11. The method of claim 6, further comprising:
prompting the user to submit personal information including a user photo; and
updating the psychographic resume with the personal information.

12. The method of claim 6, further comprising:
generating one or more graphical timelines defining time periods associated with periods of time when the user was employed and studied in college; and
updating the psychographic resume with the one or more graphical timelines.

13. The method of claim 6, further comprising hosting the psychographic resume at a web server, wherein the psychographic resume is at least a part of a web page.

14. The method of claim 6, further comprising:
based on the one or more assertions, generating a skill-like matrix, wherein the skill-like matrix is a two-dimensional chart in which abscissa represents a level of preference, while an axis of ordinates represents a skill level, or vice versa; and
updating the psychographic resume with the skill-like matrix.

15. The method of claim 14, further comprising:
based on the user request, selectively providing one or more graphical elements associated with various skills, abilities, work activities, and work styles;
prompting the user to provide the one or more assertions associated with the user preferences with respect to the skills, abilities, work activities, and work styles by prompting the user to drag and place the graphical elements onto the skill-like matrix.

16. The method of claim 14, further comprising:
dynamically updating the list of predetermined occupations being the most favorable for the user when the user make changes to the skill-like matrix.

17. The method of claim 1, wherein calculating the scores comprises:
retrieving a predetermined set of work activities, work styles and their rankings related to each of the predetermined occupations;
comparing the one or more assertions inputted by the user with the predetermined set of work activities, work styles, and their rankings;
determining differences between the one or more assertions and the predetermined set of work activities, work styles, and their rankings related to each predetermined occupation; and
calculating the scores based on the differences or a corresponding derivative of the differences.

18. The method of claim 1, wherein selectively identifying the list of predetermined occupations being the most favorable for the user comprises:
comparing the scores of each occupation to a predetermined value; and
selecting those occupations that have an associated score above the predetermined value.

19. A system for job seeking, the system comprising:
a communication module configured to receive, from a user, a user request to search job openings, wherein the user request comprises a desired work field and user education information;
an assertion module configured to prompt the user to provide information comprising one or more assertions associated with user preferences with respect to one or more work activities and one or more work styles, wherein the work activities include skills and abilities of the user;
a calculation module configured to calculate scores associated with a plurality of predetermined occupations, wherein the calculating is based on the user request and the information, wherein the scores identify how the user fits every predetermined occupation; and
an identifying module configured to selectively identify a list of predetermined occupations being the most favorable for the user.

20. A computer-readable medium having instructions stored thereon, which when executed by one or more computers, causes the one or more computers to:
receive, from a user, a user request to search job openings, wherein the user request comprises a desired work field and user education information;
based on the user request, prompt the user to provide information comprising one or more assertions associated with user preferences with respect to one or more work activities and one or more work styles, wherein the work activities include skills and abilities of the user;
based on the user request and the information, calculate scores associated with a plurality of predetermined occupations, wherein the scores identify how the user fits every predetermined occupation; and
selectively identify a list of predetermined occupations being the most favorable for the user.
